(19) United States
(12) Patent Application Publication
(10) Pub. No.: US 2021/0088350 A1
(43) Pub. Date: Mar. 25, 2021

(54) SYSTEMS AND METHODS FOR DETERMINING LINK TOPOLOGY RELATIONSHIPS

(71) Applicant: BEIJING DIDI INFINITY TECHNOLOGY AND DEVELOPMENT CO., LTD., Beijing (CN)

(72) Inventors: Hui QIU, Beijing (CN); Haibo LI, Beijing (CN); Menghua JIANG, Beijing (CN); Yuhao QIN, Beijing (CN)

(73) Assignee: BEIJING DIDI INFINITY TECHNOLOGY AND DEVELOPMENT CO., LTD., Beijing (CN)

(21) Appl. No.: 17/093,649

(22) Filed: Nov. 10, 2020

Related U.S. Application Data
(63) Continuation of application No. PCT/CN2018/114882, filed on Nov. 9, 2018.

(30) Foreign Application Priority Data
Nov. 7, 2018 (CN) 201811318572.9

(51) Int. Cl. G01C 21/34; G01C 21/36; H04L 12/751; H04L 29/08

(52) U.S. Cl. CPC G01C 21/3492; H04L 67/1031; H04L 45/02; G01C 21/3617

(57) ABSTRACT

A method for determining link topology relationships in an on-demand service area is provided. The method may include obtaining one or more historical orders associated with the on-demand service area and determining a sequence of links with respect to each of the one or more historical orders. The method may further include generating one or more link groups regarding each link of the sequence of links associated with the one or more historical orders. Each of the one or more link groups may include the each link and one or more subsequent links of the each link. The method may further include determining link topology relationships based on the one or more link groups.

### CROSS-REFERENCE TO RELATED APPLICATIONS

This application is a continuation of International Application No. PCT/CN2018/114882, filed on Nov. 9, 2018, which claims priority of Chinese Application No. 201811318572.9, filed on Nov. 7, 2018, the entire contents of which are incorporated herein by reference.

### TECHNICAL FIELD

The present disclosure generally relates to the determination of road relationships in an area, and in particular, to methods and systems for determining link topology relationships based on information associated with the online-to-offline service orders.

### BACKGROUND

Traffic in urban areas of a city has become increasingly busier than before. Technologies for evaluating and/or predicting traffic status for road segments have brought much convenience to people's commute in daily life. For instance, the prediction of traffic status may promote more efficient route planning by avoiding road segments that are likely to be congested. Moreover, the prediction of traffic status may be helpful to estimate an arrival time for arriving at a destination. The traffic status of a plurality of neighboring road segments are often inter-related due to topology relationships between the road segments. More often, the impact of one or more downstream road segments on the traffic status of an upstream road segment may be relatively greater than the impact of one or more upstream road segments on the traffic status of a downstream road segment. Therefore, it is desirable to provide systems and methods for determining link topology relationships that focus more on the impact of one or more downstream road segments on the upstream road segment.

### SUMMARY

According to an aspect of the present disclosure, a method for determining link topology relationships in an on-demand service area is provided. The method may be implemented on a computing device having at least one processor and at least one non-transitory storage medium. The method may include obtaining one or more historical orders associated with the on-demand service area and determining a sequence of links with respect to each of the one or more historical orders. The method may further include generating one or more link groups regarding each link of the sequence of links associated with the one or more historical orders. Each of the one or more link groups may include the each link and one or more subsequent links of the each link. The method may further include determining link topology relationships based on the one or more link groups.

In some embodiments, generating one or more link groups regarding each link of the sequence of links associated with the one or more historical orders may include obtaining one or more sub-sequences of links associated with the one or more historical orders by scanning the sequence of links with a preset window. For each of the one or more sub-sequences of links, generating one or more link groups regarding each link of the sequence of links associated with the one or more historical orders may include selecting a link from the sub-sequence of links to obtain a selected link and generating one or more selected link groups based on the selected link. The one or more selected link groups may include the selected link and one or more subsequent links of the selected link in the sub-sequence of links.

In some embodiments, determining the sequence of links with respect to each of the one or more historical orders may include obtaining a historical route from a starting point to an ending location with respect to each of the one or more historical orders. Determining the sequence of links with respect to each of the one or more historical orders may further include obtaining a road network associated with the on-demand service area and determining the sequence of links based on the road network and the historical route.

In some embodiments, determining link topology relationships based on the one or more link groups may include obtaining a topology relationship determination model and determining the link topology relationships by inputting the one or more link groups regarding the each link of the sequence of links into the topology relationship determination model.

In some embodiments, the topology relationship determination model may include a node2vec model or a word2vec model.

In some embodiments, the method may further include determining a first feature vector for each link of the sequence of links associated with the one or more historical orders based on the one or more link groups.

In some embodiments, determining the first feature vector for each link of the sequence of links associated with the one or more historical orders based on the one or more link groups may include determining a second feature vector for each link of the sequence of links associated with the one or more historical orders. Determining the first feature vector for each link of the sequence of links associated with the one or more historical orders based on the one or more link groups may further include determining, based on the one or more link groups, the first feature vector for each link of the sequence of links associated with the one or more historical orders by performing a dimension reduction on the second feature vector.

In some embodiments, the first feature vectors may reflect the link topology relationships.

In some embodiments, the method may further include determining a similarity between the first feature vector of a first link in the sequence of links associated with the one or more historical orders and the first feature vector of a second link in the sequence of links associated with the one or more historical orders. The method may further include determining the link topology relationship between the first link and the second link based on the similarity.

In some embodiments, the method may further include determining whether the similarity is greater than a threshold, and in response to a determination that the similarity is greater than the threshold, the method may further include generating a combined link by merging the first link and the second link.

In some embodiments, the link topology relationships may include a probability value indicating a likelihood of each of the one or more subsequent links being downstream of each link of the sequence of links associated with the one or more historical orders.

In some embodiments, the method may further including transmitting the link topology relationships to a server over a network.

According to another aspect of the present disclosure, a system for determining link topology relationships in an on-demand service area is provided. The system may include at least one storage medium storing a set of instructions and at least one processor configured to communicate with the at least one storage medium. When executing the set of instructions, the at least one processor may be directed to cause the system to obtain one or more historical orders associated with the on-demand service area and determine a sequence of links with respect to each of the one or more historical orders. The at least one processor may be further directed to cause the system to generate one or more link groups regarding each link of the sequence of links associated with the one or more historical orders. Each of the one or more link groups may include the each link and one or more subsequent links of the each link. The at least one processor may be further directed to cause the system to determine link topology relationships based on the one or more link groups.

According to yet another aspect of the present disclosure, a non-transitory computer readable medium is provided. The non-transitory computer readable medium may include a set of instructions for determining link topology relationships in an on-demand service area, wherein when executed by at least one processor, the set of instructions may direct the at least one processor to effectuate a method. The method may include obtaining one or more historical orders associated with the on-demand service area and determining a sequence of links with respect to each of the one or more historical orders. The method may further include generating one or more link groups regarding each link of the sequence of links associated with the one or more historical orders and determining link topology relationships based on the one or more link groups. Each of the one or more link groups may include the each link and one or more subsequent links of the each link.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram of an exemplary system for determining link topology relationships according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating an exemplary terminal device according to some embodiments of the present disclosure;

FIG. 4 is a block diagram illustrating an exemplary processing engine according to some embodiments of the present disclosure;

FIG. 5 is a flowchart of an exemplary process for determining link topology relationships according to some embodiments of the present disclosure;

FIG. 6 is a flowchart illustrating an exemplary process for determining one or more sequences of links according to some embodiments of the present disclosure;

FIGS. 7A-7B are schematic diagrams illustrating exemplary links according to some embodiments of the present disclosure;

FIG. 8 is a flowchart illustrating an exemplary process for generating one or more link groups according to some embodiments of the present disclosure; and

FIG. 9 is a schematic diagram illustrating exemplary link groups according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order or simultaneously. Moreover, one or more other operations may be added to the flowcharts. One or more operations may be removed from the flowcharts.

Moreover, while the systems and methods disclosed in the present disclosure are described primarily regarding online to offline services, it should also be understood that this is only one exemplary embodiment. The systems or methods of the present disclosure may be applied to any other kind of on-demand services. For example, the system or method of the present disclosure may be applied to transportation systems of different environments including land, ocean, aerospace, or the like, or a combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or a combination thereof. The transportation system may also include any transportation system for management and/or distribution, for example, a system for sending and/or receiving an express. The application of the system or method of the present disclosure may include a webpage, a plug-in of a browser, a client terminal, a custom system, an internal analysis system, an artificial intelligence robot, or the like, or a combination thereof.

The terms “passenger,” “requester,” “requestor,” “service requester,” “service requestor,” and “customer” in the present disclosure are used interchangeably to refer to an individual, an entity or a tool that may request or order a service. Also, the terms “driver,” “provider,” “service provider,” and “supplier” in the present disclosure are used interchangeably to refer to an individual, an entity or a tool that may provide a service or facilitate the providing of the service. The term “user” in the present disclosure refers to an individual, an entity or a tool that may request a service, order a service, provide a service, or facilitate the providing of the service. In the present disclosure, terms “requester” and “requester terminal” may be used interchangeably, and terms “provider” and “provider terminal” may be used interchangeably.

The terms “request,” “service,” “service request,” and “order” in the present disclosure are used interchangeably to refer to a request that may be initiated by a passenger, a requester, a service requester, a customer, a driver, a provider, a service provider, a supplier, or the like, or a combination thereof. The service request may be accepted by any one of a passenger, a requester, a service requester, a customer, a driver, a provider, a service provider, or a supplier. The service request may be chargeable or free.

The positioning technology used in the present disclosure may include a global positioning system (GPS), a global navigation satellite system (GLONASS), a compass navigation system (COMPASS), a Galileo positioning system, a quasi-zenith satellite system (QZSS), a Beidou navigation satellite system, a wireless fidelity (WiFi) positioning technology, or the like, or any combination thereof. One or more of the above positioning technologies may be used interchangeably in the present disclosure. For example, the GPS-based method and the WiFi-based method may be used together as positioning technologies to locate a wireless device.

The present disclosure provides mechanisms (which can include methods, systems, computer-readable medium, etc.) for determining link topology relationships. For instance, one or more historical orders associated with an on-demand service area may be obtained. The one or more historical orders may include one or more historical routes. A sequence of links with respect to each of the one or more historical routes may be obtained. One or more link groups may be generated regarding each link of the sequence(s) of links associated with the one or more historical routes. Each link group may include the each link and one or more subsequent links of the each link. In some embodiments, the link topology relationships may be determined based on the one or more link groups. For instance, a topology relationship determination model (e.g., a word2vec model, a node2vec model) may be obtained and trained using the one or more link groups regarding each link of the sequence of links to determine the link topology relationships. In some embodiments, the link topology relationships may include a likelihood of the one or more subsequent links being downstream (or ranked after) each link of the sequence of links. In some embodiments, a first feature vector for each link of the sequence of links may be determined using the topology relationship determination model. The first feature vectors may reflect the link topology relationships. For example, if the similarity (e.g., cosine similarity) between first feature vectors of a first link and a second link from the sequence of links is close to 1, the first link and the second link may be topologically close. The methods for determining the link topology relationships provided in the present disclosure may more accurately determine the interconnection between an upstream link and one or more downstream links, and thus the impact of the downstream link(s) on the upstream link may be more effectively evaluated or predicted.

As used herein, when used in association with transportation services, the term “link” refers to a road segment toward a direction. In some embodiments, a vehicle may traverse the road segment from two opposite directions (traversing two different links). In some embodiments, a route of the vehicle may be represented by a sequence of links that the vehicle has traversed along the route. In some embodiments, the term “link” may also be applied to other fields related to a network, such as a social network, a gene regulatory network, an airline network, or the like. For example, if a person A follows a person B in a social network application (e.g., Facebook, Twitter, Weibo), the link may include the following relationship from the person A to the person B.

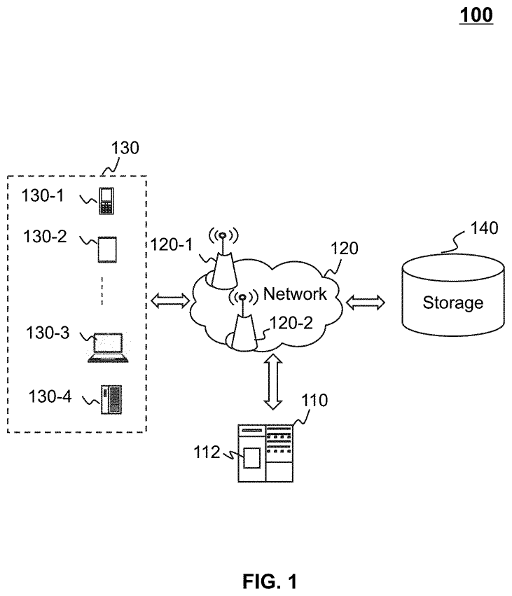

FIG. 1 is a schematic diagram of an exemplary system for determining link topology relationships according to some embodiments of the present disclosure. For example, the system 100 may be a service platform for on-demand services. The system 100 may include a server 110, a network 120, a user terminal 130, and a storage 140 (also referred to as a database). The server 110 may include a processing engine 112.

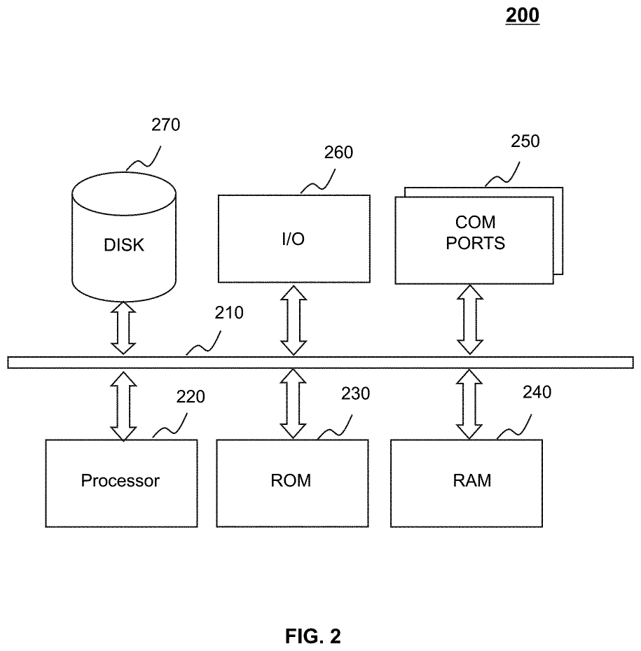

The server 110 may be configured to process information related to the system 100. For example, the server 110 may obtain one or more historical orders associated with the on-demand service area from the storage 140 via the network 120. As another example, the server 110 may determine link topology relationships based on the one or more historical orders. In some embodiments, the server 110 may be a single server or a server group. The server group may be centralized or distributed (e.g., the server 110 may be a distributed system). In some embodiments, the server 110 may be local or remote. For example, the server 110 may access information and/or data stored in the user terminal 130, and/or the storage 140 via the network 120. As another example, the server 110 may be directly connected to the user terminal 130, and/or the storage 140 to access information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components illustrated in FIG. 2 in the present disclosure.

In some embodiments, the server 110 may include a processing engine 112. The processing engine 112 may process information related to the system 100 to perform one or more functions of the server 110 described in the present disclosure. In some embodiments, the processing engine 112 may obtain one or more historical orders associated with an on-demand service area. The processing engine 112 may further determine a sequence of links with respect to each of the one or more historical orders. For each link of the sequence of links associated with the one or more historical orders, the processing engine 112 may generate one or more link groups. In some embodiments, the processing engine 112 may determine the link topology relationships based on the one or more link groups. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the system 100 (e.g., the server 110, the user terminal 130, and/or the storage 140) may transmit information and/or data to other component(s) in the system 100 via the network 120. For example, the server 110 may obtain/acquire one or more historical routes from the user terminal 130 and/or the storage 140 via the network 120. In some embodiments, the network 120 may be any type of wired or wireless network, or a combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof. In some embodiments, the network 120 may include one or more network access points. For example, the network 120 may include wired or wireless network access points such as base stations and/or internet exchange points 120-1, 120-2, . . . , through which one or more components of the system 100 may be connected to the network 120 to exchange data and/or information.

The user terminal 130 may be associated with a user. In some embodiments, a user may modify a default value and/or a setting related to topology relationships via the user terminal 130. For example, the user may modify a preset size of a preset window for scanning the sequence of links. In some embodiments, the user may input an instruction to direct one or more components of the system 100 to perform one or more operations. For instance, the instruction may direct the processing engine 112 to transmit the link topology relationships to the server 110 and/or the storage 140. In some embodiments, the user terminal 130 may be used by a service provider and may transmit the locations of the service provider at predetermined time intervals, such as 30 s, 60 s. In some embodiments, the user terminal 130 may include a mobile device 130-1, a tablet computer 130-2, a laptop computer 130-3, a tabletop computer 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smartwatch, a smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, the user terminal 130 may be a wireless device with positioning technology for locating the position of the user and/or the user terminal 130.

The storage 140 may store data and/or instructions. In some embodiments, the storage 140 may store data obtained/acquired from the user terminal 130. In some embodiments, the storage 140 may store data and/or instructions that the server 110 may execute or use to perform exemplary methods described in the present disclosure. For example, the storage 140 may store a topology relationship determination model for determining link topology relationships based on one or more link groups. As another example, the storage 140 may store the link topology relationships determined by the processing engine 112. In some embodiments, the storage 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 140 may be connected to the network 120 to communicate with one or more components in the system 100 (e.g., the server 110, the user terminal 130, etc.). One or more components in the system 100 may access the data or instructions stored in the storage 140 via the network 120. In some embodiments, the storage 140 may be directly connected to or communicate with one or more components in the system 100 (e.g., the server 110, the user terminal 130, etc.). In some embodiments, the storage 140 may be part of the server 110.

In some embodiments, one or more components in the system 100 (e.g., the server 110, the user terminal 130, etc.) may have a permission to access the storage 140. In some embodiments, one or more components in the system 100 may read and/or modify information related to a user when one or more conditions are met. For example, the server 110 may obtain data from the storage 140, including one or more historical orders, a topology relationship determination model, a road network, or the like, or a combination thereof.

One of ordinary skill in the art would understand that when an element of the system 100 performs, the element may perform through electrical signals and/or electromagnetic signals. For example, when the server 110 processes a task, such as determining the link topology relationships, the server 110 may operate logic circuits in the processing engine 112 to perform such a task. When the server 110 transmits the link topology relationships to the storage 140, the processing engine 112 may generate electrical signals encoding the topological relationships. If the server 110 communicates with the storage 140 via a wired network, the output port may be physically connected to a cable, which further transmits the electrical signal to an input port of the server 110. If the server 110 communicates with the storage 140 via a wireless network, the output port of the service requester terminal 130 may be one or more antennas, which convert the electrical signal to electromagnetic signal. Within an electronic device, such as the user terminal 130, and/or the server 110, when a processor thereof processes an instruction, transmits an instruction, and/or performs an operation, the instruction and/or operation may be conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and/or software components of a computing device according to some embodiments of the present disclosure. In some embodiments, the server 110 and/or the user terminal 130 may be implemented on the computing device 200 shown in FIG. 2. For example, the processing engine 112 may be implemented on the computing device 200 and configured to perform the functions of the processing engine 112 disclosed in this disclosure.

The computing device 200 may be used to implement any component of the system 100 as described herein. For example, the processing engine 112 may be implemented on the computing device 200, via its hardware, software program, firmware, or a combination thereof. Although only one such computer is shown, for convenience, the computer functions relating to the determination of the link topology relationships as described herein may be implemented in a distributed fashion on a number of similar platforms to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may further include program storage and data storage of different forms including, for example, a disk 270, and a read-only memory (ROM) 230, or a random-access memory (RAM) 240, for various data files to be processed and/or transmitted by the computing device. The exemplary computing device may also include program instructions stored in the ROM 230, RAM 240, and/or another type of non-transitory storage medium to be executed by the processor 220. The methods and/or processes of the present disclosure may be implemented as the program instructions. The computing device 200 may also include an I/O component 260, supporting input/output between the computer and other components. The computing device 200 may also receive programming and data via network communications.

Merely for illustration, only one processor is illustrated in FIG. 2. Multiple processors 220 are also contemplated; thus, operations and/or method steps performed by one processor 220 as described in the present disclosure may also be jointly or separately performed by the multiple processors. For example, if in the present disclosure the processor 220 of the computing device 200 executes both step A and step B, it should be understood that step A and step B may also be performed by two different processors 220 jointly or separately in the computing device 200 (e.g., a first processor executes step A and a second processor executes step B or the first and second processors jointly execute steps A and B).

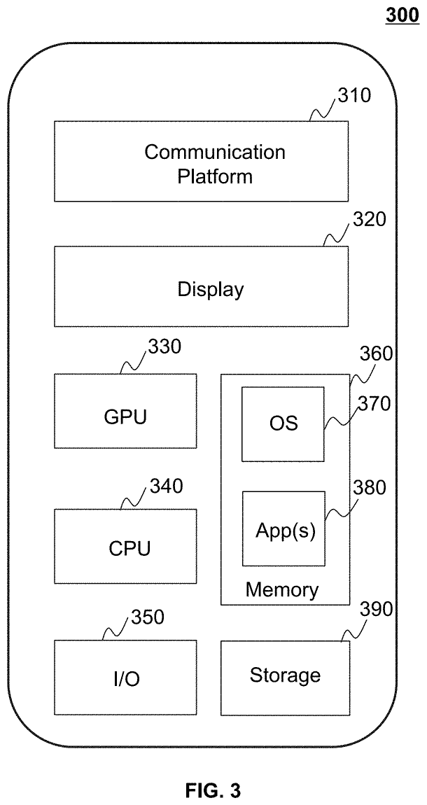

FIG. 3 is a schematic diagram illustrating exemplary hardware and/or software components of a terminal device according to some embodiments of the present disclosure. In some embodiments, the user terminal 130 may be implemented on the terminal device 300 shown in FIG. 3. The terminal device 300 may be a mobile device, such as a mobile phone, a tablet computer, a laptop computer, a built-in device on a vehicle, etc. As illustrated in FIG. 3, the mobile device 300 may include a communication platform 310, a display 320, a graphics processing unit (GPU) 330, a central processing unit (CPU) 340, an I/O 350, a memory 360, a mobile operating system (OS) 370, and a storage 390. In some embodiments, any other suitable component, including but not limited to a system bus or a controller (not shown), may also be included in the mobile device 300.

In some embodiments, the mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to on-demand services or other information from the on-demand service system 100. User interactions with the information stream may be achieved via the I/O 350 and provided to the processing engine 112 and/or other components of the on-demand service system 100 via the network 120.

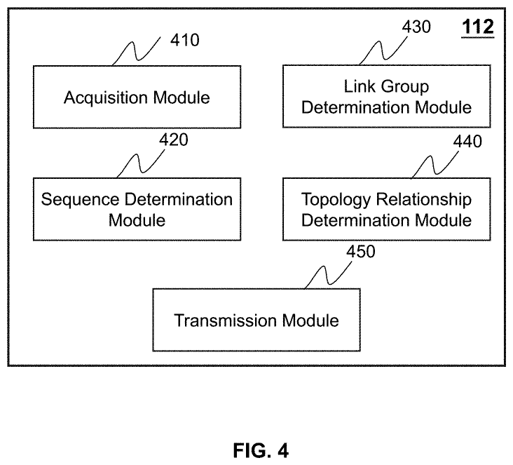

FIG. 4 is a block diagram illustrating an exemplary processing engine according to some embodiments of the present disclosure. The processing engine 112 may be in communication with a storage medium (e.g., the storage 140 of the system 100, and/or the storage 390 of the terminal device 300), and may execute instructions stored in the storage medium. In some embodiments, the processing engine 112 may include an acquisition module 410, a sequence determination module 420, a link group determination module 430, a topology relationship determination module 440, and a transmission module 450. In some embodiments, the processing engine 112 may be integrated into the server 110.

The acquisition module 410 may be configured to acquire data/information associated with the system 100. In some embodiments, the acquisition module 410 may obtain one or more historical orders. The one or more historical orders may be associated with an on-demand service, such as a car-hailing service, a chauffeur service, a delivery service, a carpooling service, a bus service, a shuttle service, or the like, or any combination thereof. In some embodiments, the acquisition module 410 may obtain a topology relationship determination model from a storage device (e.g., the ROM 230, the RAM 240). The topology relationship determination model may include but not limited to a word2vec model, a node2vec model, a Laplacian Eigenmap model, a Large-scale Information Network Embedding (LINE) model, or the like, or any combination thereof.

The sequence determination module 420 may determine a sequence of links with respect to each of the one or more historical orders. The sequence of links may indicate how a vehicle (e.g., associated with a service provider) in the historical order moved in a road network. In some embodiments, the sequence determination module 420 may determine the sequence of links with respect to each of the one or more historical orders based on a road network and one or more historical routes associated with the one or more historical orders. For example, the sequence determination module 420 may match the locations of a service provider (e.g., a driver) at different time points from the starting point to the ending point (e.g., a destination) to the road network associated with the on-demand service area. In some embodiments, the sequence of links may be represented by a sequence of link IDs, such as link 1, link 2, link 3, link 4, link 5.

The link group determination module 430 may determine one or more link groups. In some embodiments, the link group determination module 430 may obtain one or more sub-sequences of links by scanning the sequence of links with a preset window. The preset window may have a preset size. The preset size may determine the preset number of links in a sub-sequence of links. In some embodiments, the preset size may be any suitable size, such as 3, 4, 5, 8, 10, 15, etc. In some embodiments, for each of the one or more sub-sequences of links, the link group determination module 430 may select a link from the sub-sequence of links to obtain a selected link. For instance, the link group determination module 430 may select a link ranked first in the sub-sequence of links. In some embodiments, the link group determination module 430 may generate one or more selected link groups based on the selected link from the sub-sequence of links. The one or more selected link groups may include the selected link and one or more subsequent links of the selected link in the sub-sequence of links. In some embodiments, the one or more link groups regarding each link of the sequence of links may include the one or more selected link groups regarding the selected link from each of the one or more sub-sequences of links.

The topology relationship determination module 440 may determine the link topology relationships based on the one or more link groups. In some embodiments, the topology relationship determination module 440 may determine the link topology relationships using the link topology relationship determination model. For instance, the topology relationship determination module 440 may input the one or more link groups regarding each link of the sequence of links into the link topology relationship determination model to train the topology relationship determination model. In some embodiments, the topology relationship determination module 440 may determine the link topology relationships based on a training result of the topology relationship determination model. In some embodiments, the link topology relationships may include a probability value that indicates a likelihood of each of the one or more subsequent links being downstream of each link of the sequence of links associated with the one or more historical orders. In some embodiments, the topology relationship determination model may generate a first feature vector for each link of the sequence of links associated with the one or more historical orders through a training process. The first feature vectors may reflect the link topology relationships. For instance, the link topology relationship between a first link and a second link in the sequence of links associated with the one or more historical orders may be obtained by determining a similarity (e.g., a cosine similarity) between the first feature vector for the first link and the first feature vector for the second link. In some embodiments, the topology relationship determination module 440 may determine whether the similarity is greater than a threshold. In response to a determination that the similarity is greater than the threshold, the topology relationship determination module 440 may generate a combined link by merging the first link and the second link. For example, the processing engine may predict the traffic status of the second link and designate the traffic status of the second link as the traffic status of the combined link, rather than respectively predicting the traffic status of the first link and the second link.

The transmission module 450 may transmit the link topology relationships and/or the first feature vectors to a server over a network. In some embodiments, the link topology relationships and/or the first feature vectors may be stored in a storage device (e.g., the ROM 230, the RAM 240). In some embodiments, the probability value that indicates the likelihood of each of the one or more subsequent links being downstream of each link of the sequence of links may be used in a navigation service. In some embodiments, the network may be any type of wired or wireless network, or a combination thereof.

The modules in FIG. 4 may be connected to or communicate with each other via a wired connection or a wireless connection. The wired connection may include a metal cable, an optical cable, a hybrid cable, or the like, or a combination thereof. The wireless connection may include a Local Area Network (LAN), a Wide Area Network (WAN), a Bluetooth, a ZigBee, a Near Field Communication (NFC), or the like, or a combination thereof. In some embodiments, two or more of the modules may be combined into a single module, and any one of the modules may be divided into two or more units.

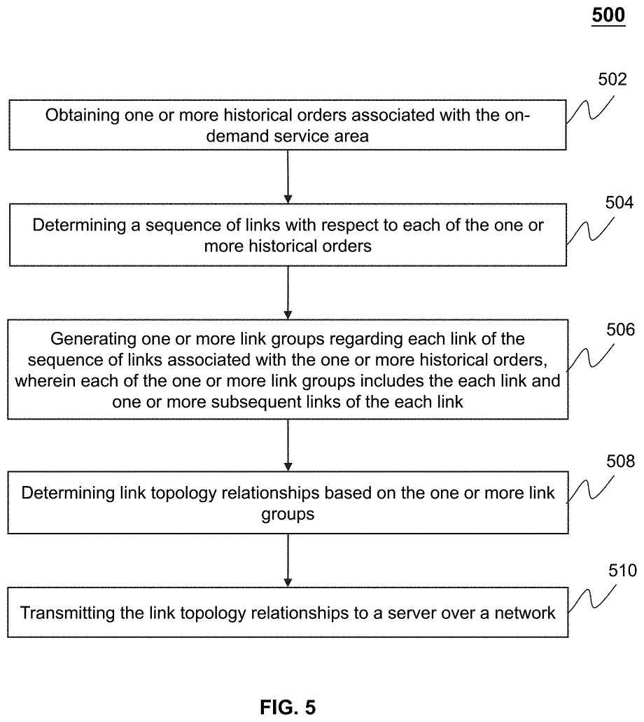

FIG. 5 is a flowchart of an exemplary process for determining link topology relationships according to some embodiments of the present disclosure. The process 500 may be executed by the on-demand service system 100. For example, the process 500 may be implemented as a set of instructions (e.g., an application) stored in the storage (e.g., ROM 230 or RAM 240 of the computing device 200). The processing engine 112 and/or modules in FIG. 4 may execute the set of instructions, and when executing the instructions, the processing engine 112 and/or the modules may be configured to perform the process 500. The operations of the illustrated process 500 presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting.

In 502, the processing engine 112 (e.g., the acquisition module 410) may obtain one or more historical orders associated with the on-demand service area. In some embodiments, a requester (e.g., a passenger) may initiate a service request and the service request may be transmitted to a service provider (e.g., a driver). The service provider may provide a service in response to the service request to complete an order. In some embodiments, the historical order may be related to a historical on-demand service. The on-demand service may include but not limited to a car-hailing service, a chauffeur service, a delivery service, a carpooling service, a bus service, a shuttle service, or the like, or any combination thereof. In some embodiments, the historical order may include a historical route from a starting point (e.g., a start location) to an ending point (e.g., a destination). The historical route may include a plurality of locations along the historical route. The locations may be acquired by a terminal device associated with the service provider using positioning technologies such as the global positioning system (GPS). In some embodiments, the one or more historical orders may correspond to various statistical time periods and/or regions. As an example, the statistical time period may include one week, one month, or one season (spring, summer, autumn, and winter). The statistical time period may include peak hours such as a time period on the way to work and a time period on the way home after work (e.g., 8:00 am-9:30 am, 5:00 pm-6:30 pm) and non-peak hours. Additionally or alternatively, the periodic statistical time period may include a weekday, a weekend, a holiday, etc. The regions may include but not limited to a county, a town, a city, a province, a country, a continent, or the like, or any combination thereof. In some embodiments, the terms “region” and “on-demand service area” may be used interchangeably. In some embodiments, the processing engine 112 may utilize historical orders corresponding to various statistical time periods and/or regions for determining link topology relationships in various statistical time periods and/or regions.

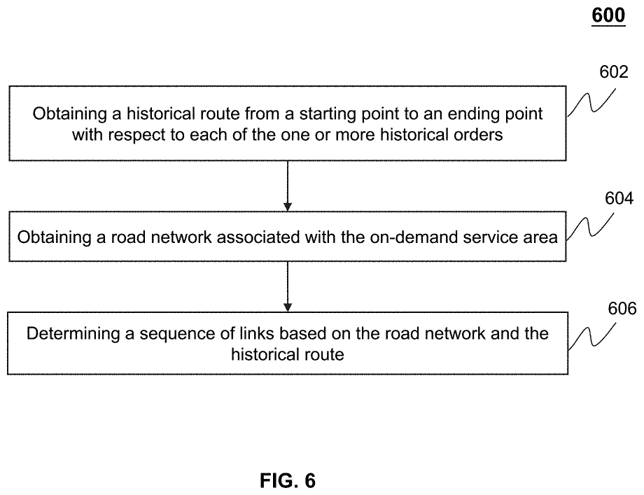

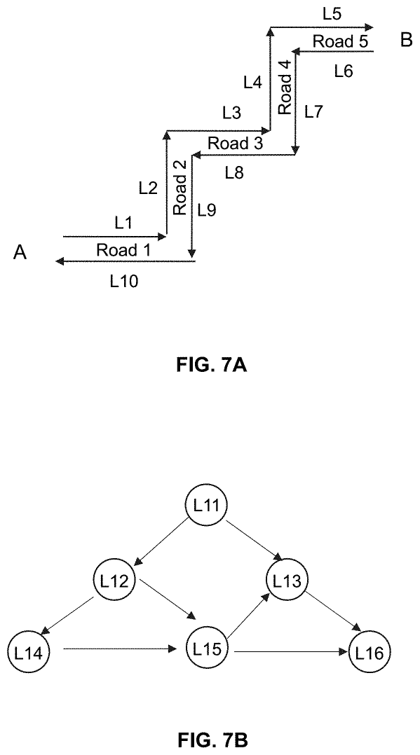

In 504, the processing engine 112 (e.g., the sequence determination module 420) may determine a sequence of links with respect to each of the one or more historical orders. As used herein, the term “a sequence of links” may refer to a plurality of links ranked in a specific order based on a historical route associated with a historical order. In some embodiments, the sequence of links may indicate how a vehicle (e.g., associated with a service provider) moved in a road network in the historical order. The processing engine 112 may obtain the road network associated with an on-demand service area from a storage device (e.g., ROM 230 or RAM 240 in FIG. 2). In some embodiments, the processing engine 112 may determine the sequence of links with respect to each of the one or more historical orders based on the road network and one or more historical routes associated with the one or more historical orders. Details regarding the determination of the sequence of links may also be found elsewhere in the present disclosure, for example, in FIG. 6, FIG. 7A and FIG. 7B, and the descriptions thereof.

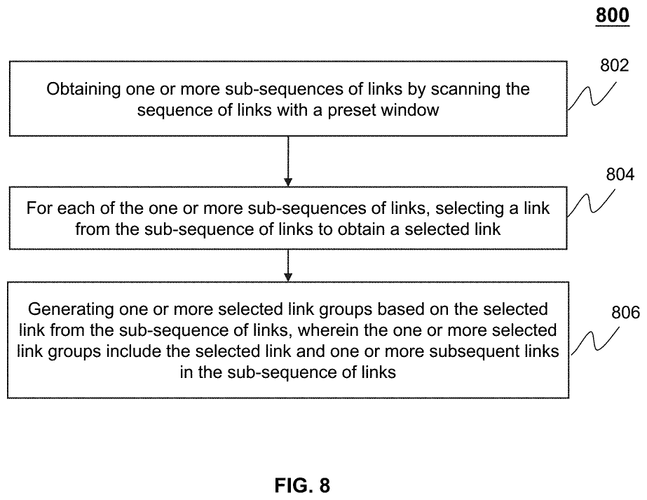

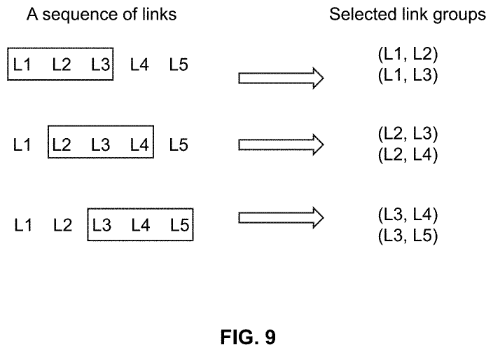

In 506, the processing engine 112 (e.g., the link group determination module 430) may generate one or more link groups regarding each link of the sequence of links associated with the one or more historical orders, wherein each of the one or more link groups may include the each link and one or more subsequent links of the each link. In some embodiments, the processing engine 112 may determine all the subsequent links being downstream of (or ranked after) each link in one or more sequences of links associated with the one or more historical orders. The one or more link groups may include each link and one or more of all the subsequent links being downstream of each link. In some embodiments, the processing engine 112 may obtain one or more sub-sequences of links by scanning the sequence of links with a preset window. For each of the one or more sub-sequences of links, the processing engine 112 may generate one or more selected link groups based on the selected link from the sub-sequence of links. The one or more selected link groups may include the selected link and one or more subsequent links in the sub-sequence of links. The one or more link groups regarding each link may include the one or more selected link groups regarding each selected link corresponding to each of the one or more sub-sequences of links. Details regarding generating the one or more selected link groups may be also found elsewhere in the present disclosure, for example, in FIGS. 8-9 and the descriptions thereof.

In 508, the processing engine 112 (e.g., the topology relationship determination module 440) may determine link topology relationships based on the one or more link groups. As used herein, the term “link topology relationships” refers to the relationships between any two links from the sequence of links associated with the one or more historical orders, independent of the dimensions, the type, etc. In some embodiments, processing engine 112 may obtain a topology relationship determination model and determine the link topology relationships using the topology relationship determination model. For example, the processing engine 112 may input the one or more link groups regarding each link of the sequence of links into the link topology relationship determination model to train the topology relationship determination model. The topology relationship determination model may include a word2vec model, a node2vec model, a Laplacian Eigenmap model, a Large-scale Information Network Embedding (LINE) model, or the like, or any combination thereof. In the following description, the word2vec model is used as an example for describing the determination of the link topology relationships.

The word2vec model may include two formats, a continuous bag of words (CBOW) model or a skip-gram model. When the one or more link groups are used to train the CBOW model, the trained CBOW model may be configured to predict the selected link from the one or more subsequent links. When the one or more link groups are used to train the skip-gram model, the trained skip-gram model may predict the subsequent links of the selected link. In some embodiments, the processing engine 112 may determine the link topology relationships based on a training result of the skip-gram model. In some embodiments, the link topology relationships may include a probability value that indicates a likelihood of each of the one or more subsequent links being downstream of each link of the sequence of links associated with the one or more historical orders. In some embodiments, the skip-gram model may generate a first feature vector for each link of the sequence of links associated with the one or more historical orders through a training process. Before training, each link of the sequence of links associated with the one or more historical orders may be represented with a second feature vector. For instance, the second feature vector may be represented by a one-hot encoding with a relatively large dimension (e.g., 10 thousand, 100 thousand, 1000 thousand, etc.) The processing engine 112 may determine the first feature vector by performing a dimension reduction on the second feature vector based on the one or more link groups. Merely by way of example, the dimension of the first feature vector may be a value between 50-300, such as 64, 128, 256, etc. In some embodiments, the first feature may be represented by floating-point numbers. In some embodiments, for a sequence of links L₁, L₂, L₃, . . . , L_{T}, the loss function E of the skip-gram model may be represented by the following equation (1):

$$E = - \frac{1}{T} {\sum }_{t = 1}^{T} {\sum }_{j = 1}^{k} log p ( {L}_{t + j} \vert {L}_{t} ) , \qquad ( 1 )$$

where T refers to the number of links in the sequence of links, k is the size of the preset window, p refers to the probability of correctly predicting the subsequent link Lₜ₊ⱼ given the link Lₜ, t=1, 2, . . . , T, and j=1, 2, . . . , k. The probability of correctly predicting the subsequent link Lᵢ given the link L_{g} may be determined according to the following equation (2):

$$p ( {L}_{i} \vert {L}_{g} ) = \frac{exp ( {u}_{{L}_{i}}^{T} {v}_{{L}_{g}} )}{{\sum }_{l = 1}^{V} exp ( {u}_{l}^{T} {v}_{{L}_{g}} )} , \qquad ( 2 )$$

where u_{L}_{ᵢ} refers to the second feature vector of the subsequent link Lᵢ, v_{L}_{ⱼ} refers to the first feature vector of the given link Lᵢ, V refers to the total number of all the links in the one or more subsequences associated with the one or more historical orders, and I=1, 2, . . . , V. In some embodiments, the skip-gram model and/or the CBOW model may be trained using a gradient descent based on a back propagation rule, so as to minimize the loss function.

In 510, the process engine 112 (e.g., the transmission module 450) may transmit the link topology relationships to a server over a network. In some embodiments, the probability value(s) indicating a likelihood of the one or more subsequent links being downstream of each link of the sequence of links associated with the one or more historical orders may be stored in a storage device (e.g., the ROM 230, the RAM 240). The processing engine 112 (e.g., the acquisition module 410) may access the storage device and obtain the probability value(s) when in need. In some embodiments, the probability value(s) may be used in a navigation service. For instance, when there are more than one possible route from a start location to a destination and impact factors such as time to be consumed and/or cost for the more than one possible route are close, the processing engine 112 may determine a link at which the more than one possible route starts to be different. The processing engine 112 may determine the likelihood of one or more subsequent links being downstream of the link, and rank the more than one possible route based on the likelihood. For example, the processing engine 112 may transmit the more than one possible route ranked in a descending order based on the likelihood to a terminal device associated with a service requester.

In some embodiments, the first feature vectors may reflect the link topology relationships. The processing engine 112 may determine the link topology relationship between a first link and a second link in the sequence of links associated with the one or more historical orders by determining a similarity between the first feature vector for the first link and the first feature vector for the second link. For instance, the similarity may be a cosine similarity. In some embodiments, the cosine similarity may range from [−1,1]. For example, when the cosine similarity is −1, it indicates that the first feature vectors for the first link and the second link are exactly opposite; when the cosine similarity is 1, it indicates that the first feature vectors for the first link and the second link are exactly the same; when the cosine similarity is 0, it indicates that the first link and the second link are unrelated; and when the cosine similarity is an intermediate value between 0−1 or −1-0, the cosine similarity indicates an extent of how much the first link and the second link are related or unrelated, respectively. In some embodiments, the processing engine 112 (e.g., the transmission module 450) may transmit the first feature vectors to the server over the network. In some embodiments, the first feature vectors may be inputted to a prediction model. For example, the prediction model may be configured to predict a traffic status of a target link based on the traffic status of one or more subsequent links determined based on the first feature vectors. As another example, the prediction model may be configured to predict an arrival time based on the predicted traffic status of the one or more subsequent links.

In some embodiments, after determining the similarity between the first feature vector for the first link and the first feature vector for the second link, the processing engine 112 may determine whether the similarity is greater than a threshold. Merely by way of example, the threshold may be 0.95, 0.92, 0.88, 0.84, 0.80, or the like. In response to a determination that the similarity is greater than the threshold, the processing engine 112 may generate a combined link by merging the first link and the second link. The similarity that is greater than the threshold may suggest that the first link and the second link often occur together in a link group associated with the one or more historical orders. In some embodiments, the first link and the second link in the combined link may share similar features (e.g., the traffic status) and the combined link may be used for processing related to the first link and the second link. For example, the processing engine may predict the traffic status of the second link and designate the traffic status of the second link as the traffic status of the combined link, rather than respectively predicting the traffic status of the first link and the second link.

In some embodiments, the processing engine 112 may transmit the trained topology relationship determination model to the server. The trained topology relationship determination model may be configured to determine one or more subsequent links of a given link. For instance, the given link may be inputted into the trained topology relationship determination model, and the trained topology relationship determination model may output one or more subsequent links and one or more probability values indicating the likelihood for each of the one or more subsequent links being downstream of the given link. In some embodiments, at least a portion of the one or more subsequent links and the corresponding probability value(s) may be used to predict the traffic status of the given link.

It should be noted that the above description is merely provided for the purposes of illustration, and not intended to limit the scope of the present disclosure. For persons having ordinary skill in the art, multiple variations and modifications may be made under the teachings of the present disclosure. However, those variations and modifications do not depart from the scope of the present disclosure.

FIG. 6 is a flowchart illustrating an exemplary process for determining a sequences of links according to some embodiments of the present disclosure. The process 600 may be executed by the on-demand service system 100. For example, the process 600 may be implemented as a set of instructions (e.g., an application) stored in the storage (e.g., ROM 230 or RAM 240 of the computing device 200). The processing engine 112 and/or modules in FIG. 4 may execute the set of instructions, and when executing the instructions, the processing engine 112 and/or the modules may be configured to perform the process 600. The operations of the illustrated process 600 presented below are intended to be illustrative. In some embodiments, the process 600 may be accomplished with one or more additional operations not described, and/or without one or more of the operations discussed. Additionally, the order in which the operations of the process 600 as illustrated in FIG. 6 and described below is not intended to be limiting.

In 602, the processing engine 112 (e.g., the sequence determination module 420) may obtain a historical route from a starting point to an ending point with respect to each of the one or more historical orders. In some embodiments, the historical route may include a sequence of geographical coordinates. For instance, the terminal device associated with the service provider may transmit geographical coordinates to the server over the network at predetermined time intervals (e.g., 30 s, 60 s). A sequence of geographical coordinates may indicate the locations of the service provider at different time points from a starting point (e.g., a starting location) to an ending point (e.g., a destination).

In 604, the processing engine 112 (e.g., the sequence determination module 420) may obtain a road network associated with the on-demand service area. In some embodiments, the road network may include a plurality of road segments in the on-demand service area. The on-demand service area may include but not limited to a county, a town, a city, a province, a country, a continent, or the like, or any combination thereof. In some embodiments, the processing engine 112 may obtain the road network associated with the on-demand service area through a storage device (e.g., the ROM 230 or the RAM 240). In some embodiments, the processing engine 112 may obtain the road network associated with the on-demand service area through the server 110.

In 606, the processing engine 112 (e.g., the sequence determination module 420) may determine a sequence of links based on the road network and the historical route. In some embodiments, the processing engine 112 may match the locations of the service provider at different time points from the starting point to the ending point (e.g., a destination) to the road network associated with the on-demand service area. For instance, the processing engine 112 may project the locations to the road network, so as to determine a sequence of road segments describing the one or more historical routes. The sequence of road segments may be converted to a sequence of links. In some embodiments, the sequence of links may be represented by a sequence of link IDs, such as link 1, link 2, link 3, link 4, link 5. In some embodiments, each link in the sequence of links may be represented by a second feature vector with a relatively high dimension (e.g., 10 thousand, 100 thousand, 1000 thousand). In some embodiments, each of the one or more historical routes may correspond to a sequence of links. In some embodiments, the processing engine 112 may generate a route network including a plurality of routes based on the one or more historical routes and the road network (e.g., as shown in FIG. 7B). The one or more sequences of links may be determined using a random walking algorithm, including but not limited to a DeepWalk algorithm, a Breadth-First-Search (BFS) algorithm, a Depth-First-Search (DFS) algorithm, or the like, or any combination thereof. In some embodiments, the random walking algorithm may direct the processing engine 112 to randomly generate a sequence of links based on the route network. In some embodiments, the sequence of links generated by the random walking algorithm may have a predetermined number of links, such as 3, 5, 8, etc. Details regarding the determination of the sequence of links associated with the one or more historical orders may also be found elsewhere in the present disclosure, for example, in FIGS. 7A-7B and the descriptions thereof.

It should be noted that the above description is merely provided for the purposes of illustration, and not intended to limit the scope of the present disclosure. For persons having ordinary skill in the art, multiple variations and modifications may be made under the teachings of the present disclosure. However, those variations and modifications do not depart from the scope of the present disclosure.

FIGS. 7A-7B are schematic diagrams illustrating exemplary links according to some embodiments of the present disclosure. FIG. 7A is a schematic diagram illustrating exemplary sequences of links determined based on a historical route and a road network. As shown in FIG. 7A, a location A and a location B may be different locations in a road network. In some embodiments, the location A is a starting point and the location B is an ending point. A first historical route for a vehicle travelling from location A to the location B may be Road 1, Road 2, Road 3, Road 4, and Road 5. As used herein, the term “road” refers to a full length of a street, an avenue, or the like, or a segment thereof, or any combination thereof. The processing engine 112 may determine a sequence of links based on the road segments along a historical route. The sequence of links corresponding to the first historical route may be L1, L2, L3, L4, and L5. In some embodiments, the location B is the starting point and the location A is the ending point. A second historical route for a vehicle travelling from location B to location A may be Road 5, Road 4, Road 3, Road 2, and Road 1. The sequence of links corresponding to the second historical route may be L6, L7, L8, L9, and L10. As illustrated in FIG. 7A, if a road segment can be traversed from two opposite directions, two different links associated with the road segment may be present. For instance, link 1 and link 10 are associated with the same Road 1, but the directions of link 1 and link 10 are opposite.

As shown in FIG. 7B, a part of a route network may include a plurality of links (the road segments are not shown) that are interconnected. The processing engine 112 may generate a sequence of links using a random walking algorithm, such as the DeepWalk algorithm, the BFS algorithm, a DFS algorithm, etc. In some embodiments, the sequence of links may have a predetermined number of links, such as 3, 4, 5, 8, etc. For instance, as shown in FIG. 7B, a first exemplary sequence of links having four links may include L11, L12, L14, L15. As another example, a second exemplary sequence of links having three links may include L11, L13, L16. The predetermined number may be a default value determined by the system 100, and/or may be adjusted by a user via a terminal device.

It should be noted that the above description is merely provided for the purposes of illustration, and not intended to limit the scope of the present disclosure. For persons having ordinary skill in the art, multiple variations and modifications may be made under the teachings of the present disclosure. However, those variations and modifications do not depart from the scope of the present disclosure.

FIG. 8 is a flowchart illustrating an exemplary process for generating one or more link groups according to some embodiments of the present disclosure. The process 800 may be executed by the on-demand service system 100. For example, the process 800 may be implemented as a set of instructions (e.g., an application) stored in the storage (e.g., ROM 230 or RAM 240 of the computing device 200). The processing engine 112 and/or modules in FIG. 4 may execute the set of instructions, and when executing the instructions, the processing engine 112 and/or the modules may be configured to perform the process 800. The operations of the illustrated process 800 presented below are intended to be illustrative. In some embodiments, the process 800 may be accomplished with one or more additional operations not described, and/or without one or more of the operations discussed. Additionally, the order in which the operations of the process 800 as illustrated in FIG. 8 and described below is not intended to be limiting.

In 802, the processing engine 112 (e.g., the link group determination module 430) may obtain one or more sub-sequences of links by scanning the sequence of links with a preset window. In some embodiments, the preset window may have a preset size. The preset size may determine the preset number of links in a sub-sequence of links. For example, the preset size may be any suitable size, such as 3, 4, 5, 8, 10, 15, etc. In some embodiments, the preset size may be a default value determined by the system 100 or may be adjusted by a user via the user terminal. In some embodiments, scanning the sequence of links may include moving the preset window along the sequence of links. At each location of the preset window, the processing engine 112 may obtain a sub-sequence of links including the preset number of links. In some embodiments, the processing engine 112 may move the preset window by one or more links at each time until the last link in the sequence of links is included in the preset window. The number of links in the last sub-sequence of links may be equal to or less the preset number. Other methods of dividing the sequence of links into one or more sub-sequences of links may also be implemented in the present disclosure, which does not depart from the scope of the present disclosure. In some embodiments, the processing engine 112 may determine the one or more link groups based on the sub-sequences of links. In some embodiments, the processing engine 112 may determine the one or more link groups directly based on the one or more sequences of links without dividing the sequence of links into one or more sub-sequences of links.

In 804, for each of the one or more sub-sequences of links, the processing engine 112 (e.g., the link group determination module 430) may select a link from the sub-sequence of links to obtain a selected link. For instance, the processing engine 112 may select a link ranked first in the sub-sequence of links. In some embodiments, one or more selected links corresponding to the one or more sub-sequences of links may cover each link in the sequence of links.

In 806, the processing engine 112 (e.g., the link group determination module 430) may generate one or more selected link groups based on the selected link from the sub-sequence of links, wherein the one or more selected link groups may include the selected link and one or more subsequent links in the sub-sequence of links. In some embodiments, the one or more link groups regarding each link of the sequence of links may include the one or more selected link groups regarding the selected link from each of the one or more sub-sequences of links. In some embodiments, the one or more selected link groups may be used to train the topology relationship determination model, as described in operation 508 in FIG. 5. Detailed descriptions regarding the generation of one or more selected link groups may also be found elsewhere in the present disclosure, for example, in FIG. 9 and the descriptions thereof.

It should be noted that the above description is merely provided for the purposes of illustration, and not intended to limit the scope of the present disclosure. For persons having ordinary skill in the art, multiple variations and modifications may be made under the teachings of the present disclosure. However, those variations and modifications do not depart from the scope of the present disclosure.

FIG. 9 is a schematic diagram illustrating exemplary link groups according to some embodiments of the present disclosure. An exemplary sequence of links is shown in FIG. 9. The sequence of links has 5 links, including L1, L2, L3, L4, and L5. Merely by way of example, the preset size of the preset window for scanning the sequence of links is 3. When the preset window is at a first location (e.g., a starting position) in the sequence of links, the processing engine may obtain a first sub-sequence of links including L1, L2, and L3. For instance, the first selected link in the first sub-sequence of links may be L1. The selected link groups corresponding to the first sub-sequence of links may include (L1, L2) and (L1, L3). When the preset window is moved along the sequence of links by one link and is located at a second location, the processing engine may obtain a second sub-sequence of links including L2, L3, and L4. For instance, the second selected link in the second sub-sequence of links may be L2. The selected link groups corresponding to the second sub-sequence of links may include (L2, L3) and (L2, L4). When the preset window is further moved along the sequence of links by one link and is located at a third location, the processing engine may obtain a third sub-sequence of links including L3, L4, and L5. For example, the third selected link in the third sub-sequence of links may be L3. The selected link groups corresponding to the third sub-sequence of links may include (L3, L4) and (L3, L5).

It should be noted that the above description is merely provided for the purposes of illustration, and not intended to limit the scope of the present disclosure. For persons having ordinary skill in the art, multiple variations and modifications may be made under the teachings of the present disclosure. However, those variations and modifications do not depart from the scope of the present disclosure. For example, the preset size of the preset window may include any suitable size, such as 2, 4, etc.

The methods provided in the present disclosure may include using one or more link groups associated with historical orders to train a topology relationship determination model, so as to determine link topology relationships, where each of the one or more link groups may include a link in a sequence of links determined based on the historical orders and one or more subsequent links of the link. The link topology relationships determined in this way may reflect the interconnection between an upstream link and one or more downstream links more accurately, and thus the impact of the downstream link(s) on the upstream link may be more effectively evaluated or predicted.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer-readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in a combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations thereof is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may have fewer features than a single foregoing disclosed embodiment.

1. A method implemented on a computing device having at least one processor and at least one non-transitory storage medium for determining link topology relationships in an on-demand service area, the method comprising:
obtaining one or more historical orders associated with the on-demand service area;
determining a sequence of links with respect to each of the one or more historical orders;
generating one or more link groups regarding each link of the sequence of links associated with the one or more historical orders, wherein each of the one or more link groups includes the each link and one or more subsequent links of the each link; and
determining link topology relationships based on the one or more link groups.

2. The method of claim 1, wherein generating one or more link groups regarding each link of the sequence of links associated with the one or more historical orders includes:
obtaining one or more sub-sequences of links associated with the one or more historical orders by scanning the sequence of links with a preset window; and
for each of the one or more sub-sequences of links,
selecting a link from the sub-sequence of links to obtain a selected link; and
generating one or more selected link groups based on the selected link, wherein the one or more selected link groups include the selected link and one or more subsequent links of the selected link in the sub-sequence of links.

3. The method of claim 1, wherein determining the sequence of links with respect to each of the one or more historical orders includes:
obtaining a historical route from a starting point to an ending location with respect to each of the one or more historical orders;
obtaining a road network associated with the on-demand service area; and
determining the sequence of links based on the road network and the historical route.

4. The method of claim 1, wherein determining link topology relationships based on the one or more link groups includes:
obtaining a topology relationship determination model; and
determining the link topology relationships by inputting the one or more link groups regarding the each link of the sequence of links into the topology relationship determination model.

5. The method of claim 4, wherein the topology relationship determination model includes a node2vec model or a word2vec model.

6. The method of claim 1, further including:
determining a first feature vector for each link of the sequence of links associated with the one or more historical orders based on the one or more link groups.

7. The method of claim 6, wherein determining the first feature vector for each link of the sequence of links associated with the one or more historical orders based on the one or more link groups includes:
determining a second feature vector for each link of the sequence of links associated with the one or more historical orders; and
determining, based on the one or more link groups, the first feature vector for each link of the sequence of links associated with the one or more historical orders by performing a dimension reduction on the second feature vector.

8. The method of claim 6, wherein the first feature vectors reflect the link topology relationships.

9. The method of claim 8, further comprising:
determining a similarity between the first feature vector of a first link in the sequence of links associated with the one or more historical orders and the first feature vector of a second link in the sequence of links associated with the one or more historical orders; and
determining the link topology relationship between the first link and the second link based on the similarity.

10. The method of claim 9, further including:
determining whether the similarity is greater than a threshold; and
in response to a determination that the similarity is greater than the threshold, generating a combined link by merging the first link and the second link.

11. The method of claim 1, wherein the link topology relationships include a probability value indicating a likelihood of each of the one or more subsequent links being downstream of each link of the sequence of links associated with the one or more historical orders.

12. (canceled)

13. A system for determining link topology relationships in an on-demand service area, comprising:
at least one storage medium storing a set of instructions; and
at least one processor configured to communicate with the at least one storage medium, wherein when executing the set of instructions, the at least one processor is directed to cause the system to:
obtain one or more historical orders associated with the on-demand service area;
determine a sequence of links with respect to each of the one or more historical orders;
generate one or more link groups regarding each link of the sequence of links associated with the one or more historical orders, wherein each of the one or more link groups includes the each link and one or more subsequent links of the each link; and
determine link topology relationships based on the one or more link groups.

14. The system of claim 13, wherein to generate the one or more link groups regarding the each link of the sequence of links associated with the one or more historical orders, the at least one processor is directed to cause the system to:
obtain one or more sub-sequences of links associated with the one or more historical orders by scanning the sequence of links with a preset window; and
for each of the one or more sub-sequences of links,
select a link from the sub-sequence of links to obtain a selected link; and
generate one or more selected link groups based on the selected link, wherein the one or more selected link groups include the selected link and one or more subsequent links of the selected link in the sub-sequence of links.

15. The system of claim 13, wherein to determine the sequence of links with respect to each of the one or more historical orders, the at least one processor is directed to cause the system to:
obtain a historical route from a starting point to an ending location with respect to each of the one or more historical orders;
obtain a road network associated with the on-demand service area; and
determine the sequence of links based on the road network and the historical route.

16. The system of claim 13, wherein to determine the link topology relationships based on the one or more link group, the at least one processor is directed to cause the system to:
obtain a topology relationship determination model; and
determine the link topology relationships by inputting the one or more link groups regarding the each link of the sequence of links into the topology relationship determination model.

17. The system of claim 16, wherein the topology relationship determination model includes a node2vec model or a word2vec model.

18. The system of claim 13, wherein the at least one processor is further directed to cause the system to:
determine a first feature vector for each link of the sequence of links associated with the one or more historical orders based on the one or more link groups.

19. The system of claim 18, wherein to determine the first feature vector for each link of the sequence of links associated with the one or more historical orders based on the one or more link groups, the at least one processor is directed to cause the system to:
determine a second feature vector for each link of the sequence of links associated with the one or more historical orders; and
determine, based on the one or more link groups, the first feature vector for each link of the sequence of links associated with the one or more historical orders by performing a dimension reduction on the second feature vector.

20. The system of claim 18, wherein the first feature vectors reflect the link topology relationships.

21-24. (canceled)

25. A non-transitory computer readable medium, comprising a set of instructions for determining link topology relationships in an on-demand service area, wherein when executed by at least one processor, the set of instructions direct the at least one processor to effectuate a method, the method comprising:
obtaining one or more historical orders associated with the on-demand service area;
determining a sequence of links with respect to each of the one or more historical orders;
generating one or more link groups regarding each link of the sequence of links associated with the one or more historical orders, wherein each of the one or more link groups includes the each link and one or more subsequent links of the each link; and
determining link topology relationships based on the one or more link groups.
